(19) United States
(12) Patent Application Publication
(10) Pub. No.: US 2015/0336493 A1
(43) Pub. Date: Nov. 26, 2015

(54) VEHICLE SEAT

(71) Applicant: TS TECH CO., LTD., Asaka-shi, Saitama (JP)

(72) Inventor: Masato Watanabe, Tochigi (JP)

(73) Assignee: TS TECH CO., LTD., Asaka-shi, Saitama (JP)

(21) Appl. No.: 14/758,204

(22) PCT Filed: Dec. 27, 2013
(86) PCT No.: PCT/JP2013/085254

§ 371 Date: Jun. 26, 2015

(30) Foreign Application Priority Data
Dec. 28, 2012 (JP) 2012-288617

(51) Int. Cl. B60N 2/68; B60N 2/58; B60N 2/22

(52) U.S. Cl. CPC B60N 2/688; B60N 2/22; B60N 2/58

(57) ABSTRACT

A seat with a reclining device makes possible avoiding deformation of a reclining cover, a portion of which is opposed to a seat belt. The reclining device links a seat back frame to a seat cushion frame so that the seat back frame is rotatable to the seat cushion frame. A reclining cover covering the reclining device is provided with a cover reinforcing portion opposed to and contactable with the seat belt. The reclining cover is arranged between a first belt guide disposed on the top end of a right side frame and a second belt guide provided on the downward extension of the right side frame. By way of the first belt guide, the second belt guide and the cover reinforcing portion, the seat belt is arranged opposed to and along the back surface of the right side frame from the top end to the bottom end thereof.

### CROSS REFERENCE TO RELATED APPLICATIONS

This application is a National Stage Entry application of PCT Application No. PCT/JP2013/085254, filed Dec. 27, 2013, which claims the priority benefit of Japanese Patent Application No. 2012-288617, filed Dec. 28, 2012, the contents being incorporated herein by reference.

### BACKGROUND

Disclosed herein is a vehicle seat, and particularly, a vehicle seat with a seat cover, which is provided with a seat belt.

Conventionally, a vehicle seat which includes: a seat body having a seat cushion as a seating portion and a seat back as a backrest; and a seat belt for restraining an occupant, is known (for example, Japanese Patent Document No. 2004-210030 A (“the '030 Document”)).

On the other hand, an automobile seat provided with a reclining cover for covering a reclining device from the outside is also known as a seat with the reclining device (for example, Japanese Patent Document No. H07-25287 (“the '287 Document”)).

The reclining cover is attached in order to prevent foreign materials from entering the reclining device from the outside and in order to protect the reclining device from an impact or the like received from the outside.

In the vehicle seat such as in the '030 Document described above, the seat belt is arranged to move in the up-down direction along the back of a seat back frame which is a frame of the seat back.

In this case, since the seat normally has the reclining cover in the case of the seat further including the reclining device as in the '287 Document, a part of the reclining cover may make contact with the seat belt, and for example, the reclining cover may be dislocated and deformed by the repeated use or the like of the seat belt.

Therefore, in the vehicle seat provided with such seat belt and the seat cover including the reclining cover, it is desired that a part of the seat cover arranged opposed to the seat belt is inhibited from being dislocated and deformed.

Also, the seat is desired to be designed so that the number of components can be reduced while the rigidity of the seat cover including the reclining cover is secured.

Various embodiments of the present invention have been made in view of the above problems, and an object of them is to provide a vehicle seat which has a seat cover for protecting a seat body from the outside and which can suppress deformation of the seat cover arranged so that a part thereof is opposed to the seat belt.

Another object is to provide the vehicle seat that is a seat with a reclining device and that can suppress deformation of the reclining cover a part of which is arranged opposed to the seat belt.

Still another object is to provide the vehicle seat that reduces the number of components while securing the rigidity of the seat cover.

### SUMMARY

The aforementioned problems are solved by a vehicle seat that includes a seat body having a seat cushion as a seating portion and a seat back as a backrest; and a seat cover which covers at least a part of the seat body, wherein: the seat cover is disposed at a position where at least a part of the seat cover is opposite to a seat belt which restrains an occupant, and the seat cover is provided with a cover reinforcing portion formed at a portion thereof, which is opposite to the seat belt and with which the seat belt can come into contact.

Thus, the cover reinforcing portion is formed on the portion of the seat cover, which is opposed to and contactable with the seat belt. Accordingly, even if the part of the seat cover repeatedly makes contact with the seat belt, the vehicle seat which can suppress the positional displacement and deformation of the seat cover may be provided.

In this case, it is preferable that the vehicle seat further includes a reclining device that pivotally connects the seat back with the seat cushion, wherein the seat cover is a reclining cover which covers the reclining device.

Thus, with such a configuration, in the vehicle seat with the reclining device, the cover reinforcing portion is formed on the portion of the seat cover contactable with the seat belt. Therefore, the positional displacement and deformation of the reclining cover can be suppressed.

In this case, preferably, the cover reinforcing portion has a ridge projecting toward the seat belt.

Hence, the rigidity of the seat cover can be improved by a simple configuration in which the ridge is provided on the portion of the seat cover opposed to the seat belt.

In this case, preferably, the plurality of the ridges are provided and extend in an extending direction of the seat belt.

Hence, the plurality of ridges is formed on the cover reinforcing portion to extend in the extending direction of the seat belt; thereby, the rigidity of the seat cover can be further improved.

In this case, it is preferable that the seat cover has a pair of projections which project toward the seat belt and a connecting portion which connects the pair of projections together, the pair of projections being provided on both sides of a portion where the ridge or ridges are formed on the cover reinforcing portion, and the seat belt has been inserted between the pair of projections and the connecting portion.

Thus, the seat belt is inserted between the pair of projections and the connecting section. Accordingly, the seat belt can be easily brought into contact with the cover reinforcing portion of the seat cover, and thereby the positional displacement and deformation of the seat cover can be suppressed.

In this case, preferably, the pair of projections are integrally formed with the seat cover.

Thus, with such a configuration, the number of components can be reduced and the rigidity of the seat cover can be improved.

In this case, it is preferable that the seat cover includes a front wall and a rear wall facing each other, and a bottom wall which connects the rear wall and the front wall together, and the cover reinforcing portion is provided on the rear wall and extends in an up-down direction.

Thus, with such a configuration, the seat cover including the cover reinforcing portion is clearly configured, and the rigidity of the seat cover can be secured by the cover reinforcing portion provided on the rear wall.

In this case, preferably, the cover reinforcing portion is provided on the bottom wall and extends in a front-back direction of the seat from the rear wall toward the bottom wall.

As described above, the cover reinforcing portion extends from the rear wall to the bottom wall in the seat front-back direction; therefore, an area in which the cover reinforcing portion is provided can be increased and the positional displacement and deformation of the seat cover may be suppressed.

In this case, it is preferable that the seat cover has a side wall which connects the front wall and the rear wall, and the rear wall extends rearward from the side wall at an inclination relative to a right-left direction of the seat.

As described above, the rear wall extends from the side wall and inclines rearward relative to the right-left direction of the seat; therefore, the seat cover can be easily attached to the reclining device at the time of attaching the seat cover to the reclining device in the right-left direction.

In this case, it is preferable that the plurality of the ridges are provided on the rear wall at predetermined intervals in the right-left direction of the seat, and the plurality of the ridges have rising heights which gradually decrease from an end of the rear wall on a side of the side wall toward an opposite end of the rear wall.

Thus, with such a configuration, the distance between the seat belt and the plurality of ridges decreases and the seat belt can make contact with each of the plurality of ridges. Therefore, the positional displacement and deformation of the seat cover can be suppressed.

In this case, it is preferable that a seat back cover provided on a back of the seat back, wherein the cover reinforcing portion is exposed, through the seat back cover, at a region thereof where the ridge or ridges are formed.

Thus, the area of the cover reinforcing portion of the seat cover in which the ridge is formed is exposed from the seat back cover. Accordingly, the ridge is formed on the portion that is exposed from the seat back cover and susceptible to impacts from the outside; thereby, the rigidity of the seat cover can be secured.

According to various embodiments of the invention, the cover reinforcing portion is formed on the portion of the seat cover which is opposed to and contactable with the seat belt. Therefore, even if a part of the seat cover repeatedly makes contact with the seat belt, the vehicle seat which can suppress the positional displacement and deformation of the seat cover may be provided.

According to various embodiments of the invention, in the vehicle seat with the reclining device, the cover reinforcing portion is formed on the portion of the seat cover contactable with the seat belt. Therefore, the positional displacement and deformation of the reclining cover can be suppressed.

According to various embodiments of the invention, the rigidity of the seat cover can be improved by a simple configuration in which the ridge is provided on the portion of the seat cover opposed to the seat belt.

According to various embodiments of the invention, the plurality of ridges is formed on the cover reinforcing portion to extend in the extending direction of the seat belt; thereby, the rigidity of the seat cover can be further improved.

According to various embodiments of the invention, the seat belt is inserted between the pair of projections and the connecting section. Accordingly, the seat belt can be easily brought into contact with the cover reinforcing portion of the seat cover, and thereby the positional displacement and deformation of the seat cover can be suppressed.

According to various embodiments of the invention, the number of components can be reduced and the rigidity of the seat cover can be improved.

According to various embodiments of the invention, the seat cover including the cover reinforcing portion is clearly configured, and the rigidity of the seat cover can be secured by the cover reinforcing portion provided on the rear wall.

According to various embodiments of the invention, the cover reinforcing portion extends from the rear wall to the bottom wall in the seat front-back direction; therefore, an area in which the cover reinforcing portion is provided can be increased and the positional displacement and deformation of the seat cover may be suppressed.

According to various embodiments of the invention, the rear wall extends from the side wall and inclines rearward relative to the right-left direction of the seat; therefore, the seat cover can be easily attached to the reclining device at the time of attaching the seat cover to the reclining device in the right-left direction.

According to various embodiments of the invention, the distance between the seat belt and the plurality of ridges decreases and the seat belt can make contact with each of the plurality of ridges. Therefore, the positional displacement and deformation of the seat cover can be suppressed.

According to various embodiments of the invention, the area of the cover reinforcing portion of the seat cover in which the ridge is formed is exposed from the seat back cover. Accordingly, the ridge is formed on the portion that is exposed from the seat back cover and susceptible to impacts from the outside; thereby, the rigidity of the seat cover can be secured.

### BRIEF DESCRIPTION OF THE DRAWINGS

FIG. 1 is a schematic perspective view of a vehicle seat according to an embodiment of the invention;

FIG. 2 is a schematic perspective view of a seat frame of the vehicle seat of FIG. 1;

FIG. 3 is a schematic perspective and partially enlarged view of the seat frame of FIG. 2;

FIG. 4 is a schematic perspective view of a reclining cover of the vehicle seat of FIG. 1;

FIG. 5 is a schematic cross-sectional view taken along the line A-A and illustrating a portion of the seat frame in FIG. 3, which is provided with the reclining cover;

FIG. 6 is a schematic perspective and partially enlarged view of the seat frame showing a second embodiment of the present invention; and

FIG. 7 is a schematic perspective view of a vehicle seat showing the second embodiment of the present invention.

### DETAILED DESCRIPTION

### First Embodiment of the Vehicle Seat

The present embodiment relates to a vehicle seat equipped with a reclining device, the vehicle seat comprising a reclining cover having a cover reinforcing portion between a first belt guide and a second belt guide, the vehicle seat being configured so that the seat belt is disposed opposed to and along the back face of a side frame by way of the first belt guide, the second belt guide, and the cover reinforcing portion.

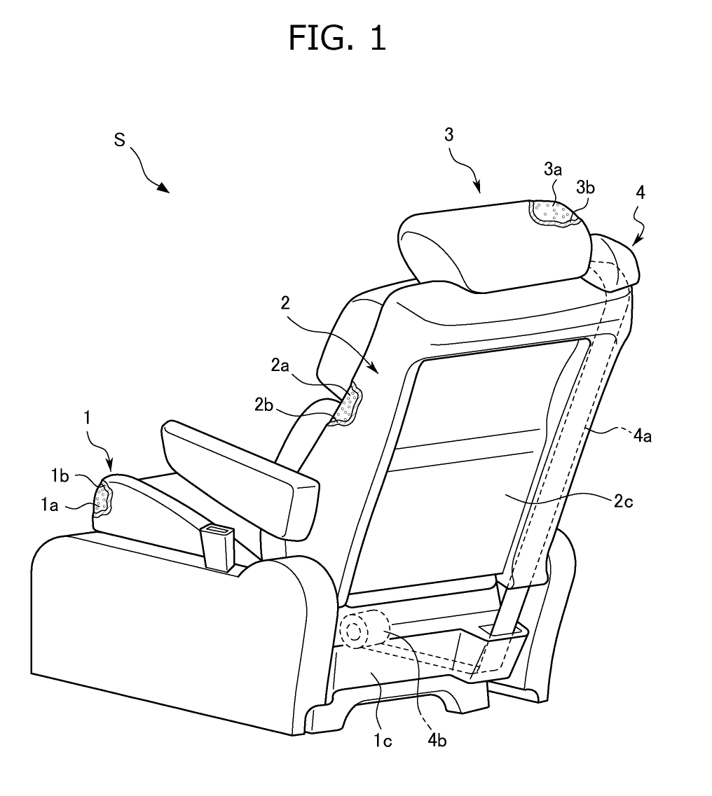

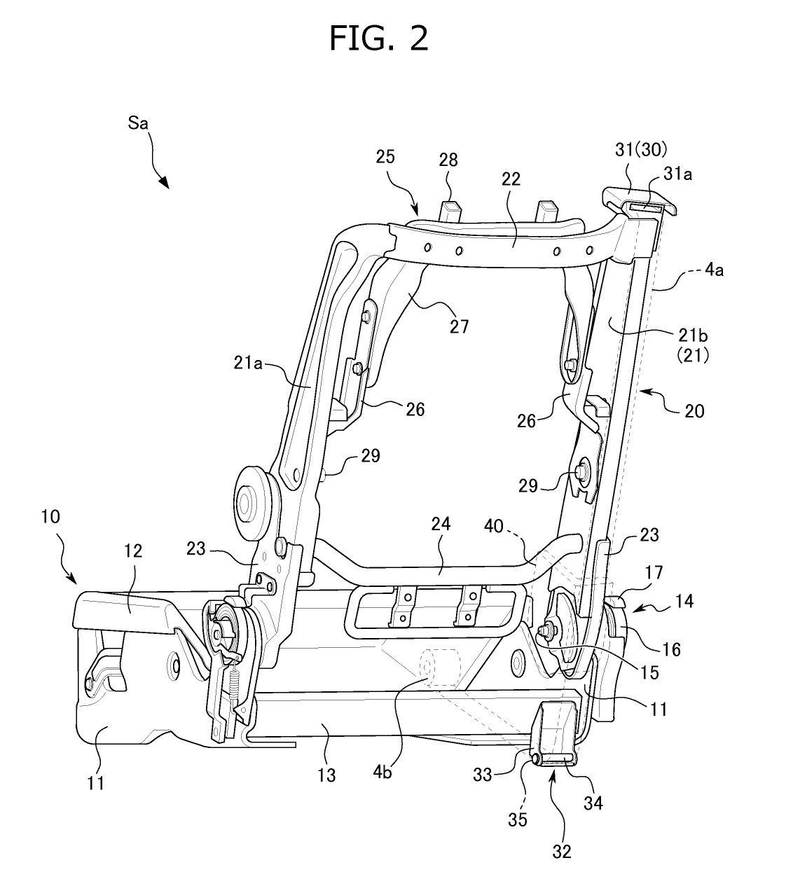

A vehicle seat S of the present embodiment is mainly configured by a seat body including: a seat cushion 1; a seat back 2 which is arranged on the upper side of the seat cushion 1; and a headrest 3 which is disposed on the upper side of the seat back 2 and by a seat belt device 4 as shown in FIG. 1. The vehicle seat S is provided with a seat frame Sa as a frame shown in FIG. 2.

Further, a side at which an occupant is seated with respect to the seat back 2 of the vehicle seat S is the front side.

The seat cushion 1 is a seating portion for supporting the occupant from below, and it is configured such that a cushion pad 1a is placed on a seat cushion frame 10 of the frame shown in FIG. 2 and the cushion pad 1a is covered with a surface material 1b. A seat cushion cover 1c for protecting the seat cushion 1 is installed on the rear side of the seat cushion 1.

The seat back 2 is a backrest portion for supporting the occupant's back from the rear and is configured such that a cushion pad 2a is placed on a seat back frame 20 of the frame shown in FIG. 2 and the cushion pad 2a is covered with a surface material 2b. A seat back cover 2c for protecting the seat back 2 is mounted on the rear side of the seat back 2.

The headrest 3 is a head portion for supporting the occupant's head from behind, and it is configured such that a cushion pad 3a placed on a pillar (not shown) of a core material is covered with a surface material 3b.

The seat belt device 4 is mainly configured by a seat belt 4a for restraining the occupant's body, a publicly-known belt retractor 4b which allows the seat belt 4a to be wound and pulled out, and a belt guide 30 shown in FIG. 2 for guiding the seat belt 4a pulled out from the belt retractor 4b.

The tip of the seat belt 4a is provided with a belt tongue plate (not shown), and the belt tongue plate is configured to be detachably connected with a belt buckle (not shown).

The seat cushion frame 10 is formed by a substantially rectangular frame body serving as a frame of the seat cushion 1. As shown in FIG. 2, the seat cushion frame 10 is mainly equipped with cushion side frames 11 disposed on the right-left sides, pan frames 12 serving as plate-shaped frames which are laid on the top surface of the front side of the respective cushion side frames 11, a cushion frame connecting pipe 13 for connecting the right-left inner surfaces of the rear side of the cushion side frames 11, and an elastic spring (not shown) for connecting the right-left inner surfaces of the cushion side frames 11 at substantially the center in the front-back direction.

The belt retractor 4b is detachably mounted to a portion which is substantially at the center of the lower end of the seat cushion frame 10 in the front-back direction and which is adjacent to the right cushion side frame 11 in the right-left direction.

The cushion side frame 11 is made of a sheet metal member extending in the front-back direction, and the left cushion side frame 11 and the right cushion side frame 11 are spaced in the right-left direction and are substantially parallel to each other.

As shown in FIG. 2, a reclining device 14 for connecting the seat back 2 to the seat cushion 1 so that the seat back 2 is rotatable to the seat cushion 1 is provided at a portion at which the cushion side frame 11 and the seat back frame 20 are connected.

The reclining device 14 is a publicly-known reclining device, and mainly includes a connecting shaft 15 as a pivot stem of the reclining device 14, a spiral spring 16 biasing the seat back frame 20 in an upright state, and a spring locking member 17 for locking the extended tip of the spiral spring 16.

The reclining device 14 is provided with a reclining cover 40 which covers the reclining device 14.

The connecting shaft 15 is formed by a pipe member having a substantially circular cross-section, and connects the cushion side frame 11 and the seat back frame 20 together.

The connecting shaft 15 is configured to extend through and fit in a shaft insertion hole (not shown) provided in a rear end of the cushion side frame 11 and a shaft through hole (not shown) provided at a lower end of corresponding one of the right-left ends of the seat back frame 20.

The spiral spring 16 is formed by a linear member of spiral shape and is provided on the rear end portion of the outer side wall, as viewed in the right-left direction, of the cushion side frame 11.

The spiral spring 16 is fixed at an end thereof to the lower end of an outer wall, as viewed in the right-left direction, of the seat back frame 20 by being hooked on the spring locking member 17, and the spiral spring 16 is locked at an opposite end thereof on a spring locking portion (not shown) provided on an outer side wall, as viewed in the right-left direction, of the cushion side frame 11.

The seat back frame 20 is formed by a substantially rectangular frame body as shown in FIG. 2, and it mainly includes right and left side frames 21 disposed on the right and left sides and extending in the up-down direction, an upper frame 22 connecting the upper ends of the right and left side frames 21, right and left lower frames 23 mounted on the right and left outer sides of the lower ends of the right and left side frames 21 and linked with the cushion side frames 11, a frame connecting pipe 24 connecting substantially lower portions of the inner surfaces of the right and left side frames 21, and a center bent frame 25 arranged to connect the substantially central portions of the inner surfaces of the right and left side frames 21 and formed into a substantially inverted U-shaped body.

A first belt guide 31 of the belt guide 30 for guiding the seat belt 4a is mounted on the upper surface of a right side frame 21b which is a right side part of the seat back frame 20, and a second belt guide 32 of the belt guide 30 is mounted on the rear surface of the cushion frame connecting pipe 13, which is an extension of the rear surface of the right side frame 21b at the lower side thereof.

Of the left and right side frames 21, the left side frame 21a on the left side has a substantially square U-shape cross-section formed by inwardly bending a sheet metal member along its right and left sides, and the right side frame 21b on the right side has a substantially square U-shaped cross-section formed by bending a sheet metal member. Both the left side frame 21a and the right side frame 21b extend in the up-down direction.

The right and left side frames 21 are configured to gradually and continuously extend forward from the top to the bottom and are spaced in the right and left direction in parallel with each other.

Through holes (not shown) for mounting the center bent frame 25 are formed at substantially central portions of the right and left side frames 21 in the up-down direction. Further, through holes (not shown) for mounting the frame connecting pipe 24 are formed at substantially lower portions of the right and left side frames 21.

The upper frame 22 has a curved shape obtained by curving a sheet metal member to the seat rear side, and it is fixed by welding to the right and left side frames 21.

The right and left lower frames 23 are each formed of a substantially U-shape obtained by bending right and left sides of a sheet member inward, and the right and left lower frames 23 extend in the up-down direction. The upper portions of the lower frames 23 are fixed by welding to the right and left side frames 21 to sandwich the right and left side frames 21 from the outer side in the right-left direction.

The shaft through-hole (not shown) for supporting the connecting shaft 15 of the reclining device 14 is formed at a lower portion of each lower frame 23, and the connecting shaft 15 is configured to be inserted in and connected to the shaft through-hole.

The frame connecting pipe 24 is formed by a substantially circular pipe member which is curved to the seat rear side. The frame connecting pipe 24 is fitted into the through holes (not shown) formed on the right and left side frames 21, thereby being connected to the side frames 21.

As shown in FIG. 2, the center bent frame 25 includes: a pair of attachment portions 26 attached to the inner surfaces of the side frames 21; and a connecting portion 27 for connecting the pair of attachment portions 26 to each other.

Each of the attachment portions 26 has a substantially crank-shape which is bent at the central portion in the up-down direction, and the upper portion of the attachment portion 26 is formed to protrude inward of the lower portion in the right-left direction.

The connecting portion 27 has a substantially inverted U-shape, and the side portions thereof are connected with the upper portions of the attachment portions 26 by bolt tightening. A pair of pillar guides 28 into which pillars (not shown) of the headrest 3 are inserted is attached to the upper portion of the connecting portion 27.

A through hole (not shown) is formed at the lower portion of the attachment portion 26. The through holes of the attachment portions 26 and through holes (not shown) of the side frames 21 are connected by pivot stems 29.

The pivot stems 29 are components configuring a publicly-known rotary device (not shown), and such rotary device is configured to connect the center bent frame 25 to the right and left side frames 21 so that the center bent frame 25 is rotatable with respect to the side frames 21 in the front-back direction about the pivot stems 29 as the rotation center.

The belt guide 30 is configured by the first belt guide 31 and the second belt guide 32 as shown in FIG. 2. The first belt guide 31 formed by a publicly-known belt guide is attached to the upper surface of the right side frame 21b, and it has a substantially rectangular insertion hole 31a for allowing insertion of the seat belt 4a in the front-back direction.

In addition, the insertion hole 31a is formed to such a size that the seat belt 4a can be inserted and that the belt tongue plate (not shown) at the tip of the seat belt 4a cannot be inserted.

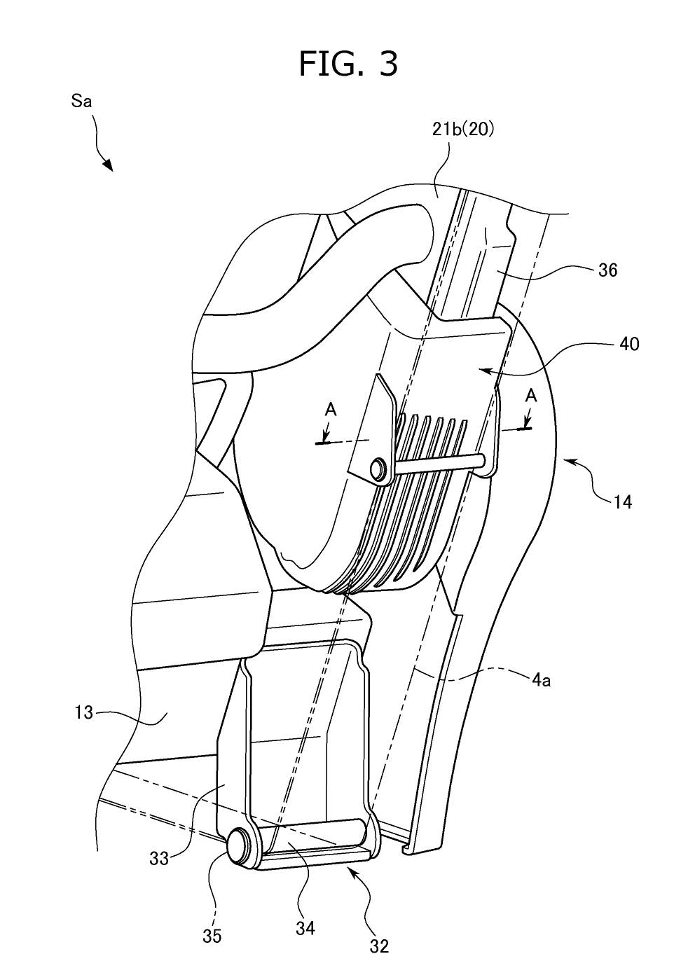

As shown in FIG. 3, the second belt guide 32 is mainly configured by an attachment portion 33 attached to the rear surface of the cushion frame connecting pipe 13 and by a guide portion 34 as a rotating member connected to a pair of through holes (not shown) formed on the right and left outside surfaces of the lower end of the attachment portion 33.

A substantially rectangular insertion hole 35 for allowing insertion of the seat belt 4a is formed on the front surface of the lower end of the attachment portion 33.

The second belt guide 32 is configured so that the seat belt 4a is inserted through the insertion hole 35 of the attachment portion 33 and is further inserted through a space between the guide portion 34 and the bottom surface of the attachment portion 33.

The seat belt 4a pulled out of the belt retractor 4b is configured to first move to the seat rear side toward the second belt guide 32 as shown in FIG. 2 to be brought into contact with the guide portion 34 of the second belt guide 32 shown in FIG. 3, thereafter moving in a manner that the belt moving direction changes in direction from the rear of the seat to the upper side of the seat. Then, as shown in FIG. 2, the seat belt 4a is configured to move along the back face of the right side frame 21b toward the first belt guide 31 to pass from the seat back side of the first belt guide 31 through the insertion hole 31a, thereafter moving in a manner that the belt moving direction changes in a direction toward the seat front side.

More specifically, the seat belt 4a, owing to the first belt guide 31 and the second belt guide 32, is disposed along the back face of the right side frame 21b from the top end to the bottom end thereof and is opposite to the back face thereof, and therefore is configured to cover the entire back face of the right side frame 21b. Here, the seat belt 4a is disposed to avoid protruding from the outer edge of the right side frame 21b in the right-left direction of the seat as shown in FIG. 3.

In addition, the belt tongue plate (not shown) is attached to the tip of the seat belt 4a pulled out to the seat front side, and the shape of the belt tongue plate is larger than the shape of the insertion hole 31a. Therefore, the seat belt 4a is held in a state where the belt tongue plate is in contact with the front side of the first belt guide 31 when the belt retractor 4b winds up the seat belt 4a.

As shown in FIG. 2, the first belt guide 31, the second belt guide 32 and the belt retractor 4b are disposed in a position to overlap the back face of the right side frame 21b in the right-left direction, and more specifically, they are disposed substantially in the same position with the back face. The seat belt 4a is configured to be positioned between the back face of the right side frame 21b and the seat back cover 2c shown in FIG. 1 in the front-back direction.

In this case, the seat back cover 2c is provided with a belt housing portion (not shown) in the position corresponding to the seat belt 4a. This belt housing portion is a recess dented from the front to the rear side of the seat back cover 2c, and it can not only accommodate the seat belt 4a but also improve the rigidity of the seat back cover 2c.

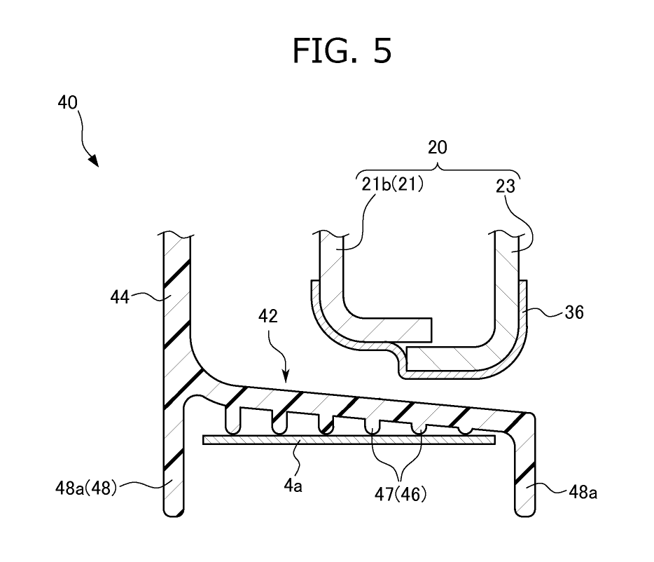

The back face of the right side frame 21b is provided with a surface member 36 as an interference suppression member for suppressing the interference between the right side frame 21b and the seat belt 4a as shown in FIG. 3 or 5. The surface member 36 is configured to extend along the back face of the right side frame 21b in the up-down direction.

As shown in FIG. 3, the reclining cover 40 is a member covering an inner side of the reclining device 14 as viewed in the right-left direction, and is formed of a synthetic resin.

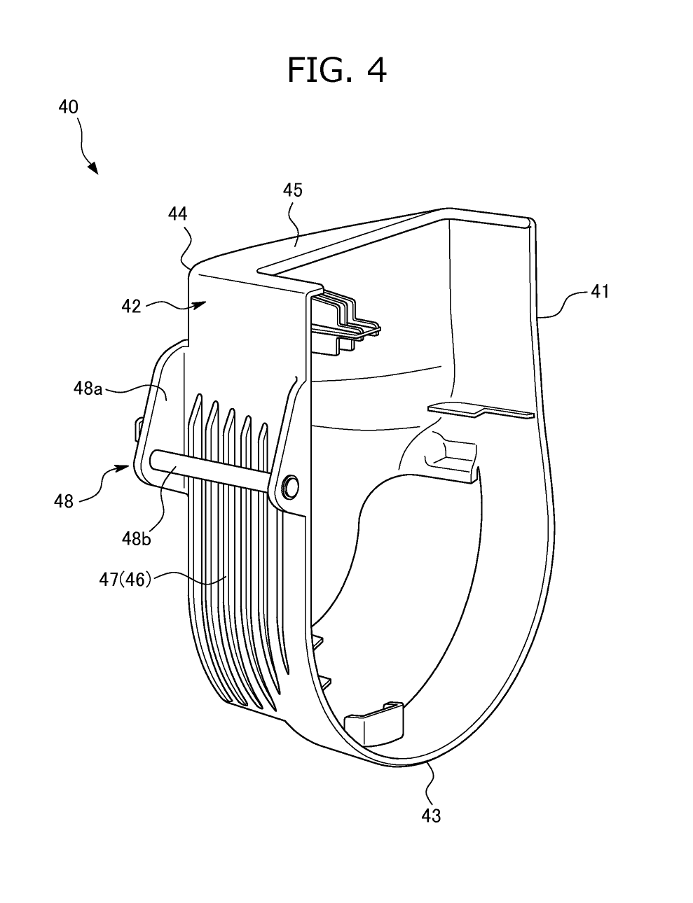

As shown in FIG. 4, the reclining cover 40 is mainly provided with a substantially rectangular plate-shaped front wall 41, a substantially rectangular plate-shaped rear wall 42 facing the front wall 41, a substantially semicircular plate-shaped bottom wall 43 connecting the lower ends of the front wall 41 and the rear wall 42, a substantially rectangular plate-shaped side wall 44 connecting the left ends of the front wall 41 and the rear wall 42, and an upper wall 45 connecting the upper ends of the front wall 41 and the rear wall 42.

Note that the lower portion of the side wall 44 has a substantially crescent-shaped opening and the opening is utilized during installation or removal of components of the reclining device 14. Further, a substantially rectangular opening is formed at the seat right portion of the upper wall 45, and the opening is formed to avoid interference with the side frame 21.

The reclining cover 40 is a member which is mounted to the reclining device 14 from the inner side to the outer side thereof in the right-left direction. As shown in FIG. 5, the rear wall 42 which covers the back of the reclining device 14 is configured to extend from the side wall 44 to incline rearward relative to the right-left direction of the seat, and the front wall 41 which covers the front of the reclining device 14 is configured to extend from the side wall 44 to incline forward relative to the right-left direction of the seat.

The reclining cover 40 is configured as described above; therefore, the reclining cover 40 can be attached to the reclining device 14 while avoiding, in the front-back direction, the right side frame 21b and the lower frame 23 that is fixed in a manner to hold the right side frame 21b at front and rear sides thereof.

As shown in FIG. 4, a cover reinforcing portion 46, which is opposite to the seat belt 4a and with which the seat belt 4a can come into contact, and a belt contact portion 48, which holds the seat belt 4a from both sides are provided on the back face of the rear wall 42.

The cover reinforcing portion 46 is provided with ridges 47 which rise toward the rear side of the seat, and these ridges 47 are formed as many as six at predetermined intervals in the right-left direction of the seat, and are configured to extend in the up-down direction.

As shown in FIG. 5, the protruding height of the ridges 47 gradually decreases from one end of the rear wall 42, which is located at the side end wall 44 to the other end of the rear wall 42, which is located at the outer side in the right-left direction.

In this case, the rear wall 42 extends from the side wall 44 to incline rearward relative to the right-left direction of the seat; therefore, the plane formed by the tips of the plural ridges 47 is substantially parallel to the right-left direction of the seat.

As shown in FIG. 4, the belt contact portion 48 is disposed on the right and left ends of the cover reinforcing portion 46, and it has a pair of projections 48a projecting toward the seat rear side and a connecting portion 48b as a rotating member connected to the through-holes (not shown) formed on the right and left outer surfaces at the ends of the pair of projections 48a.

The projections 48a are each a substantially triangular body which is integrally formed with the rear wall 42, and they are provided on the right and left sides of a portion of the cover reinforcing portion 46 in which the ridges 47 are formed. The projection 48a is configured to extend upward of the ridges 47 in the seat up-down direction.

In the above structure, as shown in FIG. 3 and FIG. 4, the seat belt 4a is arranged opposed to the ridges 47 of the cover reinforcing portion 46 in the seat up-down direction, and it is inserted between the ridges 47 and the connecting section 48b in the seat front-back direction. Additionally, the seat belt 4a is sandwiched between the pair of projections 48a in the right-left direction of the seat.

Further, as shown in FIG. 5, the seat belt 4a is provided on the back side of the right side frame 21b and the reclining cover 40, and it is arranged to form a plane substantially parallel to the right-left direction of the seat.

Since the rear wall 42 of the reclining cover 40 is located between the right side frame 21b and the seat belt 4a in the front-back direction as shown in FIG. 5, the reclining cover 40 functions as an interference suppression member suppressing the interference between the right side frame 21b and the seat belt 4a.

In addition, the seat back cover 2c shown in FIG. 1 is arranged on the seat rear side of the reclining cover 40, and the reclining cover 40 is configured so that the lower portion of the cover reinforcing portion 46 where the ridges 47 are formed is exposed from the seat back cover 2c.

### Second Embodiment of the Vehicle Seat

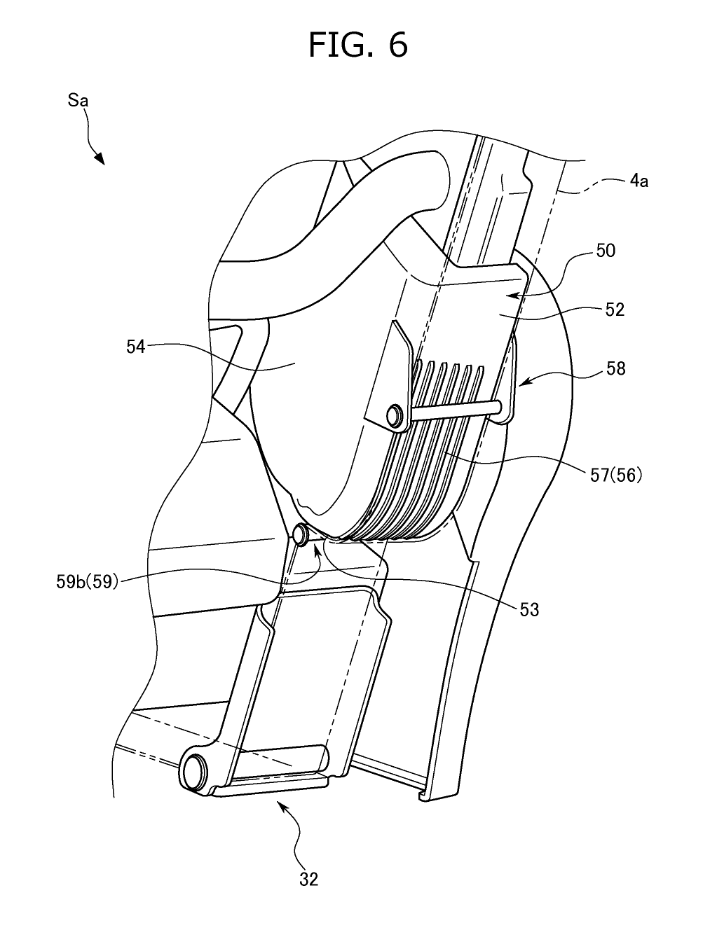

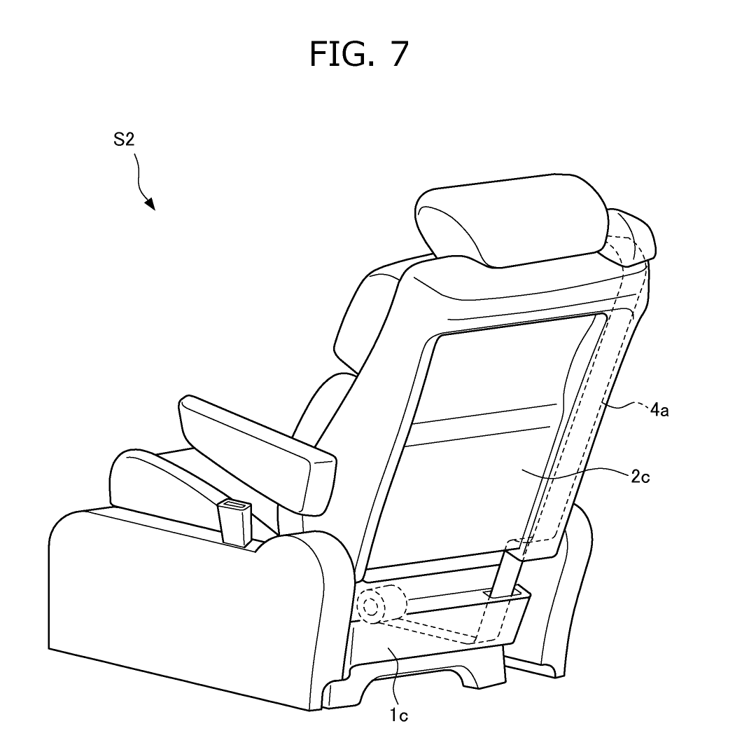

Next, a vehicle seat S2 according to the second embodiment of the present invention will be described on the basis of FIGS. 6 and 7.

The vehicle seat S2 of the second embodiment comprises an arrangement of the seat belt 4a on the seat back side that is changed and thereby the vehicle seat is more compact.

As shown in FIG. 6, a reclining cover 50 includes a cover reinforcing portion 56 provided on the back of a rear wall 52 to extend therefrom to the bottom of a bottom wall 53, a first belt contact portion 58 provided on the back of the rear wall 52, and a second belt contact portion 59 provided on the bottom of the bottom wall 53.

A ridge 57 which projects to the seat rear side is provided on the cover reinforcing portion 56 to have six ridges 57 which are formed at predetermined intervals in the right-left direction of the seat.

The ridges 57 are formed to extend along the back of the rear wall 52 in the up-down direction and to extend continuously from the lower end of the back of the rear wall 52 along the bottom surface of the bottom wall 53 in the front-back direction.

Further, a substantially crescent-shaped opening is formed on the lower portion of a side wall 54 in the same way as in the reclining cover 40; therefore, the ridges 57 extend to a portion of the bottom surface of the bottom wall 53, which is kept away from this opening.

The first belt contact portion 58 is disposed opposed to the seat belt 4a which moves in the up-down direction while being in contact with the cover reinforcing portion 56, and the second belt contact portion 59 is disposed opposed to the seat belt 4a which moves in the front-back direction while being in contact with the cover reinforcing portion 56.

In the above structure, the seat belt 4a is arranged to be opposed to the ridges 57 of the cover reinforcing portion 56 in the seat up-down direction. Specifically, the seat belt 4a is arranged to face the back of the rear wall 52, and it moves in a manner that the moving direction changes in direction at the lower portion of the back of the rear wall 52 and further changes in direction at a connecting portion 59b of the second belt contact portion 59.

The vehicle seat S2 is configured as described above; therefore, as shown in FIG. 7, the vehicle seat S2 can be configured so that the shapes of the seat cushion cover 1c and the seat back cover 2c are smaller than those of the vehicle seat S1 in the seat front-back direction. Therefore, the size of the vehicle seat can be reduced.

### Other Embodiments

The belt guide 30 of the foregoing embodiment is configured so that the seat belt 4a is arranged along the back face of the right side frame 21b as shown in FIG. 2. However, the belt guide 30 is not limited to such a configuration and may be configured so as that the seat belt 4a is arranged along the outer face of the right side frame 21b in the right-left direction. Alternatively, the belt guide 30 may be configured so that the seat belt 4a is arranged along the back face of the left side frame 21a or the outer face of the left side frame 21a in the right-left direction.

As shown in FIG. 2, according to the foregoing embodiment, the first belt guide 31 is placed on the upper surface of the right side frame 21b while the second belt guide 32 is located on the rear surface of the cushion frame connecting pipe 13. However, the first belt guide 31 and the second belt guide 32 are not limited to such a configuration. If the seat belt 4a is configured to be disposed along a predetermined surface of the side frame 21, the arrangement of the first belt guide 31, the second belt guide 32, and the belt retractor 4b may be changed appropriately.

The reclining cover 40 in the foregoing embodiment is formed of a synthetic resin, but it is not limited to such a configuration and may be formed of a metallic material or the like. The reclining cover 40 made of a synthetic resin can be lightweight, whereas the reclining cover 40 made of a metallic material can improve the rigidity.

As shown in FIG. 3, the reclining cover 40 in the foregoing embodiment is a member covering the inner portion, as viewed in the right-left direction, of the reclining device 14. However, the reclining cover 40 is not limited to such a configuration and may be configured as a member covering the outer portion, as viewed in the right-left direction, of the reclining device 14.

In such a modification, the reclining cover 40 may preferably have such a configuration that as shown in FIG. 4, the cover has an outer side wall instead of the inner side wall 44 and is applied as a member which is to be attached inward from an outside onto an outer portion of the reclining device 14, both as viewed in the right-left direction.

Further, the reclining cover 40 may be preferably configured such that the rear wall 42 which covers the back of the reclining device 14 extends rearward from the side of the side wall located on the outside at an inclination relative to the right-left direction of the seat; and that the front wall 41 which covers the front of the reclining device 14 extends forward from the side of the side wall located on the outside at an inclination relative to the right-left direction of the seat.

More preferably, the rising heights of the ridges 47 may gradually decrease from the end of the rear wall 42 on the side of the side wall located on the outside toward the inner end of the rear wall 42 as viewed in the right-left direction, and the plurality of ridges 47 may form at tops thereof a plane which is substantially parallel to the right-left direction of the seat.

As shown in FIG. 4, the back of the rear wall 42 in the foregoing embodiment is configured of a portion, where the ridges 47 are formed, and a substantially flat portion as viewed in the up-down direction, but can be appropriately modified.

For example, the ridges 47 may be formed on the entire back surface of the rear wall 42 as viewed in the up-down direction. This configuration can increase the area of contact with the seat belt 4a, and can also improve the rigidity of the reclining cover.

The projections 48a of the belt contact portion in the foregoing embodiment are integrally formed as the reclining cover 40. However, the projections 48a are not limited to such a configuration and may be configured to be separately formed and then joined to the rear wall 42.

The connecting portion 48b in the foregoing embodiment is connected as a rotatable member to the projections 48a. However, the connecting portion 48b is not limited to such a configuration and may be fixed to the projections 48a without rotation. In that case, it is preferable that the connecting portion 48b is integrally formed with the projections 48a.

In the above embodiment, the reclining cover 40 is described as an example of the seat cover which covers at least a part of the seat body, but without being limited thereto, a cover member which also covers another portion of the seat body can be employed as the seat cover.

In other words, the cover may be configured such that at least a part of the cover member is disposed at a position opposite to the seat belt 4a and a cover reinforcing portion formed on a portion of the cover, which is opposite to the seat belt 4a and with which the seat belt 4a can come into contact.

In each of the foregoing embodiments, the vehicle seat for use in an automobile is described as a specific example, but without being limited thereto, the present invention can be utilized as land vehicle seats in trains, buses and the like and as mobile craft seats in airplanes, ships and the like.

In the present embodiments, the vehicle seats according to various embodiments have been described mainly.

However, the foregoing embodiments are only examples for facilitating the understanding of the present invention and by no means limit the present invention. The present invention may be modified and improved without departing from the spirit thereof, and the present invention includes equivalents thereof as a matter of course.

In particular, regarding the configurations of the first belt guide 31, the second belt guide 32 and the reclining covers 40, 50 described in the foregoing embodiments are only examples and by no means limit the present invention.

TABLE OF REFERENCE CHARACTERS

| S, S2 | vehicle seat |
|---|---|
| Sa | seat frame |
| 1 | seat cushion |
| 1a, 2a, 3a | cushion pad |
| 1b, 2b, 3b | surface material |
| 1c | seat cushion cover |
| 2 | seat back |
| 2c | seat back cover |
| 3 | headrest |
| 4 | seat belt device |
| 4a | seat belt |
| 4b | belt retractor |
| 10 | seat cushion frame |
| 11 | cushion side frame |
| 12 | pan frame |
| 13 | cushion frame connecting pipe |
| 14 | reclining device |
| 15 | connecting shaft |
| 16 | spiral spring |
| 17 | spring locking member |
| 20 | seat back frame |
| 21 | side frame |
| 21a | left side frame |
| 21b | right side frame |
| 22 | upper frame |
| 23 | lower frame |
| 24 | frame connecting pipe |
| 25 | center bent frame |
| 26 | attachment portion |
| 27 | connecting portion |
| 28 | pillar guide |
| 29 | pivot stem |
| 30 | belt guide |
| 31 | first belt guide |
| 31a | insertion hole |
| 32 | second belt guide |
| 33 | attachment portion |
| 34 | guide portion |
| 35 | insertion hole |
| 36 | surface member |
| 40, 50 | reclining cover |
| 41 | front wall |
| 42, 52 | rear wall |
| 43, 53 | bottom wall |
| 44 | side wall |
| 45 | upper wall |
| 46, 56 | cover reinforcing portion |
| 47, 57 | ridge |
| 48 | belt contact portion |
| 48a | projection |
| 48b, 59 | bconnecting portion |
| 54 | side wall |
| 58 | first belt contact portion |
| 59 | second belt contact portion |

1. A vehicle seat, comprising:
a seat body comprising a seat cushion as a seating portion and a seat back as a backrest; and
a seat cover which covers at least a part of the seat body,
wherein:
the seat cover is disposed at a position where at least a part of the seat cover is opposite to a seat belt which restrains an occupant, and
the seat cover is provided with a cover reinforcing portion formed at a portion thereof, which is opposite to the seat belt and with which the seat belt can come into contact.

2. The vehicle seat according to claim 1, comprising:
a reclining device that pivotally connects the seat back with the seat cushion,
wherein the seat cover is a reclining cover which covers the reclining device.

3. The vehicle seat according to claim 1, wherein the cover reinforcing portion is provided with a ridge projecting toward the seat belt.

4. The vehicle seat according to claim 3, wherein a plurality of the ridges are provided and extend in an extending direction of the seat belt.

5. The vehicle seat according to claim 3, wherein:
the seat cover comprises a pair of projections which project toward the seat belt and a connecting portion which connects the pair of projections together, the pair of projections being provided on both sides of a portion where the ridge or ridges are provided on the cover reinforcing portion, and
the seat belt has been inserted between the pair of projections and the connecting portion.

6. The vehicle seat according to claim 5, wherein the pair of projections are integrally formed with the seat cover.

7. The vehicle seat according to claim 3, wherein:
the seat cover includes a front wall and a rear wall facing each other, and a bottom wall which connects the rear wall and the front wall together, and
the cover reinforcing portion is provided on the rear wall and extends in an up-down direction.

8. The vehicle seat according to claim 7, wherein the cover reinforcing portion is provided on the bottom wall and extends in a front-back direction of the seat from the rear wall toward the bottom wall.

9. The vehicle seat according to claim 7, wherein:
the seat cover comprises a side wall which connects the front wall and the rear wall, and
the rear wall extends rearward from the side wall at an inclination relative to a right-left direction of the seat.

10. The vehicle seat according to claim 9, wherein:
a plurality of the ridges are provided on the rear wall at predetermined intervals in the right-left direction of the seat, and
the plurality of the ridges have rising heights which gradually decrease from an end of the rear wall on a side of the side wall toward an opposite end of the rear wall.

11. The vehicle seat according to claim 3, further comprising:
a seat back cover provided on a back of the seat back,
wherein the cover reinforcing portion is exposed, through the seat back cover, at a region thereof where the ridge or ridges are formed.
